(19) United States
(12) Patent Application Publication
(10) Pub. No.: US 2005/0067600 A1
(43) Pub. Date: Mar. 31, 2005

(54) Valve having an actuator that integrates mechanical hard stops

(76) Inventor: Russell D. Wilfert, Chandler, AZ (US)

Correspondence Address: HONEYWELL INTERNATIONAL INC., 101 COLUMBIA ROAD, P O BOX 2245, MORRISTOWN, NJ, 07962-2245, US

(21) Appl. No.: 10/676,457

(22) Filed: Sep. 30, 2003

(51) Int. Cl. F16K 51/00

(52) U.S. Cl. 251/286

(57) ABSTRACT

A valve assembly includes mechanical hard stops that are integral with the actuator assembly. The valve assembly includes a valve body, a valve element, and an actuator assembly. The valve element is disposed within the valve body and is moveable between an open position and a closed position. The actuator assembly is coupled to the valve element and is adapted to receive one or more position control signals, and is operable to selectively move the valve element between the open and closed positions. An engagement structure is coupled to the valve element and is moveable therewith. A stop structure is fixedly coupled to the actuator assembly and is configured to engage the engagement structure when the valve is at least in one of the open and closed positions.

### STATEMENT REGARDING FEDERALLY SPONSORED RESEARCH OR DEVELOPMENT

This invention was made with Government support under contract number N00019-02-C-3002, awarded by the U.S. Navy. The Government has certain rights in this invention.

### FIELD OF THE INVENTION

The present invention relates to valve actuators and, more particularly, to a valve actuator that includes mechanical hard stops formed integral to the actuator.

### BACKGROUND OF THE INVENTION

Valves are used in myriad systems to control the flow of fluid to and from one or more systems or components. In many systems, the valves are operated using some sort of valve actuator. Such actuators include a torque source that is used to move the valve between its open and closed positions. The torque source may be, for example, a hydraulic actuator, a pneumatic actuator, or an electrical actuator, such as solenoids, and motors.

Many valves include mechanical hard stops, which are used to limit the travel of the valve at the open and closed positions of the valve. Presently, many of these hard stops are located away from the torque source. In such instances, the load path between the torque source and the hard stops may include several parts and/or features, all of which may contribute to a lack of torsional rigidity. Indeed, in some valves, the torsional deflection may be of such a magnitude that a position sensor used to determine valve position may not supply accurate position information. Such inaccuracies have led to leakage, which can lead to increased production costs. Moreover, the mechanical hard stops in some valves are machined into the bottom of a hole formed in the valve body, which can also be costly.

Hence, there is a need for a valve assembly that includes mechanical hard stops that provide increased torsional rigidity as compared to known valves, and/or reduces the number of components, and/or are relatively easy to manufacture. The present invention addresses one or more of these needs.

### SUMMARY OF THE INVENTION

The present invention provides a valve assembly that incorporates mechanical hard stops in the actuator assembly. Thus, the valve includes fewer parts between the actuator and the hard stops, which provides increased torsional rigidity and less tolerance build up at the mechanical stop locations. Including the mechanical hard stops in the actuator assembly also eliminates the difficult machining process used in certain valves.

In one embodiment, and by way of example only, a valve assembly includes a valve body, a valve element, an actuator assembly, an engagement structure, and a stop structure. The valve body has at least a fluid inlet, and a fluid outlet. The valve element is disposed at least partially within the valve body and is moveable between an open position, in which the valve body fluid inlet is in fluid communication with the valve body fluid outlet, and a closed position, in which the valve body fluid inlet is not in fluid communication with the valve body fluid outlet. The actuator assembly is coupled to the valve element and is adapted to receive one or more position control signals, and is operable, in response thereto, to selectively move the valve element between the open and closed positions. The engagement structure is coupled to the valve element and is moveable therewith. The stop structure is fixedly coupled to the actuator assembly and is configured to engage the engagement structure when the valve is at least in one of the open and closed positions.

Other independent features and advantages of the preferred valve assembly will become apparent from the following detailed description, taken in conjunction with the accompanying drawings which illustrate, by way of example, the principles of the invention.

### BRIEF DESCRIPTION OF THE DRAWINGS

FIG. 1 is a perspective exploded view of a plug valve assembly according to an exemplary embodiment of the present invention;

FIGS. 2 and 3 are cross section views of the assembled plug valve assembly shown in FIG. 1;

FIG. 4 is a perspective view of an actuator assembly according to a exemplary preferred embodiment that may be used with the valve assembly shown in FIGS. 2 and 3;

FIG. 5 cross section view of a portion of the assembled valve assembly shown in FIG. 1; and

FIG. 6 is a perspective exploded view of a valve assembly according to an exemplary alternative embodiment of the present invention.

### DETAILED DESCRIPTION OF A PREFERRED EMBODIMENT

Before proceeding with the detailed description, it is to be appreciated that the described embodiment is not limited to use in conjunction with a specific type of valve assembly. Thus, although the present embodiment is, for convenience of explanation, depicted and described as being implemented in a plug valve assembly, it will be appreciated that it can be implemented in various other types of valve assemblies.

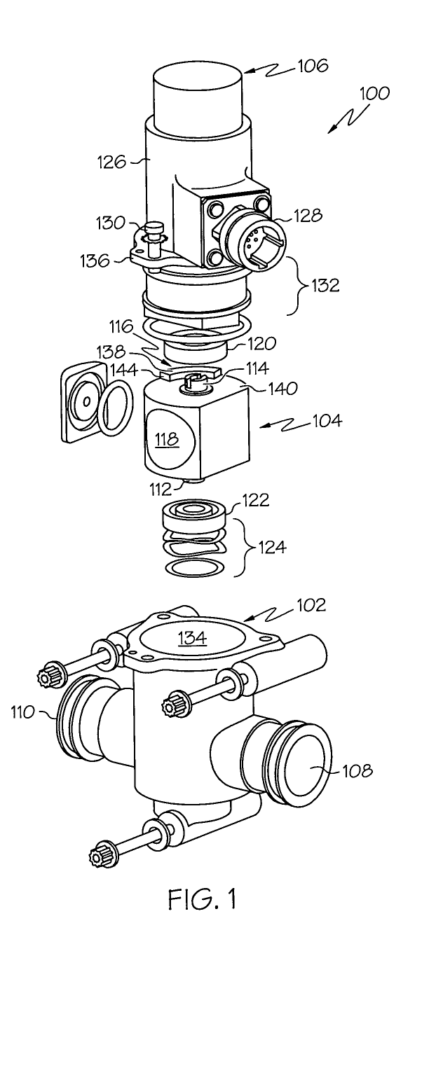

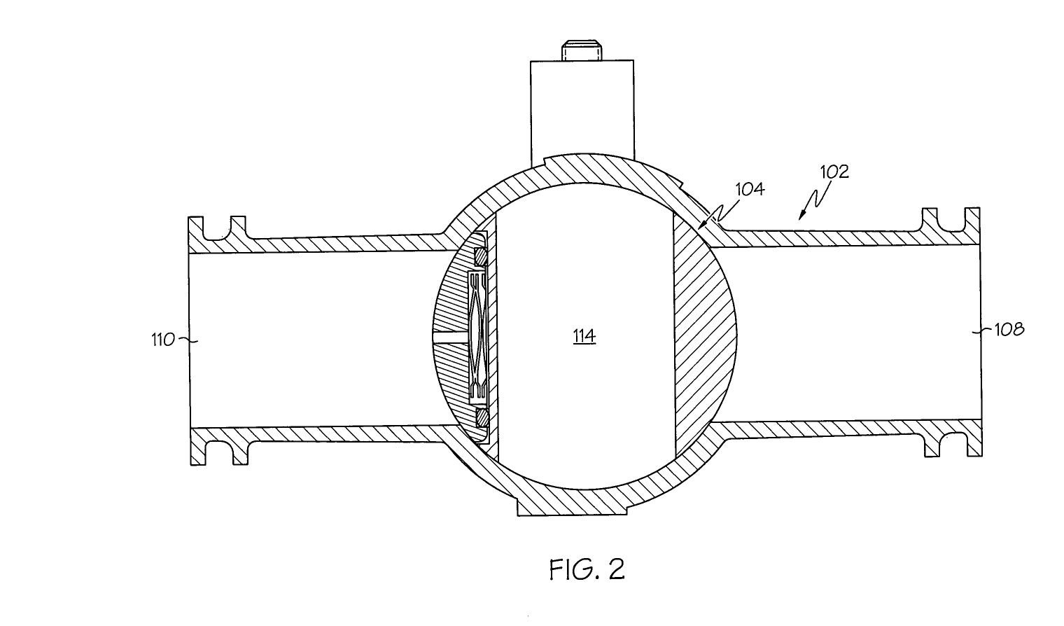

An exemplary embodiment of a valve assembly 100 is illustrated in perspective view in FIG. 1, and in two different cross section views in FIGS. 2 and 3, and is shown to include a valve body 102, a valve element 104, and an actuator assembly 106. The valve body 102 includes a fluid inlet 108, and a fluid outlet 110. The valve element 104 is mounted within the valve body 102 between the fluid inlet 108 and fluid outlet 110. In the depicted embodiment, the valve element 104 is a plug valve that is substantially cylindrical in cross section, and includes a lower shaft 112, an upper shaft 114, an engagement structure 116, and a flow passage 118 that extends through the valve element 104. As will be described more fully below, the upper shaft 114 is used to interface the valve element 104 to the actuator assembly 106. As such, it is also referred to herein as the interface shaft 114. Moreover, as was alluded to above, it will be appreciated that a plug valve is merely exemplary of one of the numerous types of valve elements that could be used.

No matter the particular type of valve element 104 used, it is seen that the valve element 104 is rotationally mounted within the valve body 102, and is moveable between a closed position and an open position. In the depicted embodiment, as shown most clearly in FIGS. 2 and 3, when the valve element 104 is in the closed position, the flow passage 118 is not in fluid communication with the valve body fluid inlet 108 and outlet 110. Thus, fluid flow through the valve assembly 100 is inhibited. Conversely, when the valve element 104 is moved to the open position, the flow passage 118 is in fluid communication with the valve body fluid inlet 108 and the valve body fluid outlet 110. Thus, fluid may flow through the valve assembly 100.

The valve element 104 may be rotationally mounted in the valve body 102 using any one of numerous types of hardware and hardware configurations. In the depicted embodiment, however, the valve element 104 is rotationally mounted using two bearing assemblies, an upper bearing assembly 120, and a lower bearing assembly 122. The upper bearing assembly surrounds the interface shaft 114, and the lower bearing assembly 122 surrounds the lower shaft 112. A spring 124 is preferably disposed between the valve body 102 and the lower bearing assembly 122. The spring 124 supplies an upward bias to inhibit axial movement of the valve element 104 and to load the upper 120 and lower 122 bearing assemblies. It will be appreciated that the valve assembly 100 could be implemented without the spring 124.

The valve actuator assembly 106 is mounted to the valve body 102, and is coupled to the valve element 104. The valve actuator assembly 106 includes a housing 126, a receptacle assembly 128, and a non-illustrated actuator. The actuator assembly housing 126 is mounted on the valve body 102, and is coupled thereto via, for example, one or more threaded fasteners 130 (only one shown). Referring to FIGS. 1 and 3 in combination, it is seen that a portion of the actuator assembly housing 126, referred to herein as the interface section 132, extends into an opening 134 formed in the valve body 102. A flange 136, which extends substantially perpendicular from the actuator housing 126, seats against a peripheral surface of the opening 134. It is through the flange 136 that the fasteners 130 extend.

The receptacle assembly 128 is coupled to the actuator assembly housing 126 and is adapted to receive valve command signals, and couple these signals to the non-illustrated actuator disposed within the actuator assembly housing 126. In response to the valve commands signals, the actuator assembly 106 selectively moves the valve element 104 between the open and closed positions. To do so, the actuator assembly 106 is coupled to the valve element 104 via an output shaft 302, which is shown most clearly in FIG. 3. In particular, the actuator assembly output shaft 302, as was alluded to above, engages the interface shaft 114 on the valve element 104. Thus, as the actuator assembly output shaft 302 rotates, the valve element 104 will correspondingly rotate.

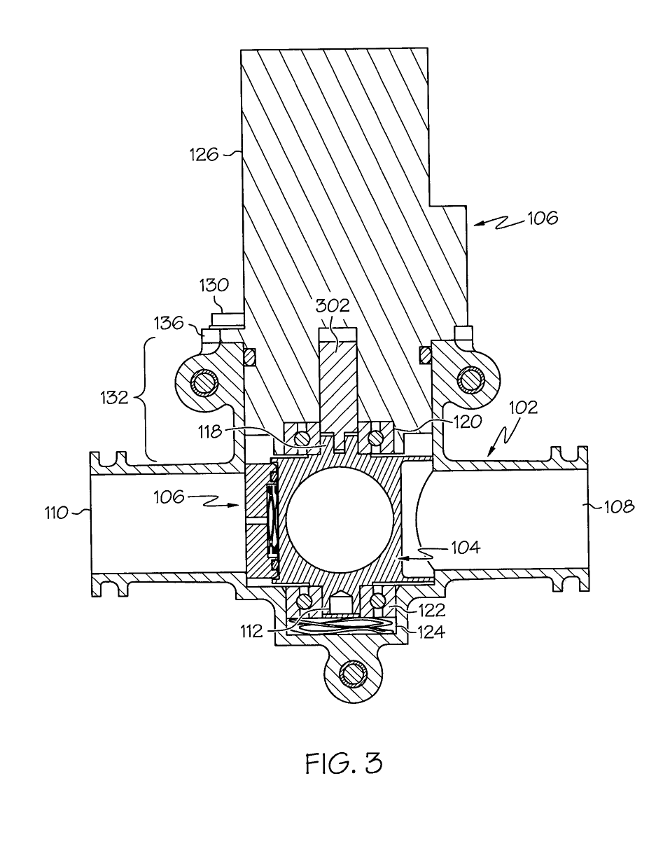

Turning now to FIG. 4, which is a perspective view of the actuator assembly 106, it is seen that the actuator assembly housing 126, and in particular the housing interface section 132, includes a stop structure 402. The stop structure 402 extends downwardly from the housing interface section 132. The stop structure 402 includes a first stop surface 404 and a second stop surface 406, which are spaced apart from one another via a substantially arcuate cavity 408. The stop structure first 404 and second 406 stop surfaces preferably extend substantially perpendicularly from the stop structure and, as will be described more fully below, selectively engage the engagement structure 116 on the valve element 104. The stop structure 402 is preferably formed as an integral part of the actuator assembly housing 126 by, for example, machining the cavity 408 into the assembly housing interface section 132. It will be appreciated, however, that the stop structure 402 could also be formed separately from the housing 126, and then coupled to thereto.

Returning briefly once again to FIG. 1, it is seen that the valve element engagement structure 116 includes a main body 138 that extends upwardly from a top surface 140 of the valve element 104. The main body 138 is substantially arcuate in shape, and includes a first engagement surface 142 and a second engagement surface 144 at its opposite ends. In the depicted embodiment, each of the engagement are preferably disposed substantially perpendicular to the valve element top surface 140. The engagement structure 116 is preferably formed as an integral part of the valve element 104 by, for example, a machining process. However, it will be appreciated that the engagement structure 116 could be formed separate from the valve element 104 and then coupled to the valve element top surface 140.

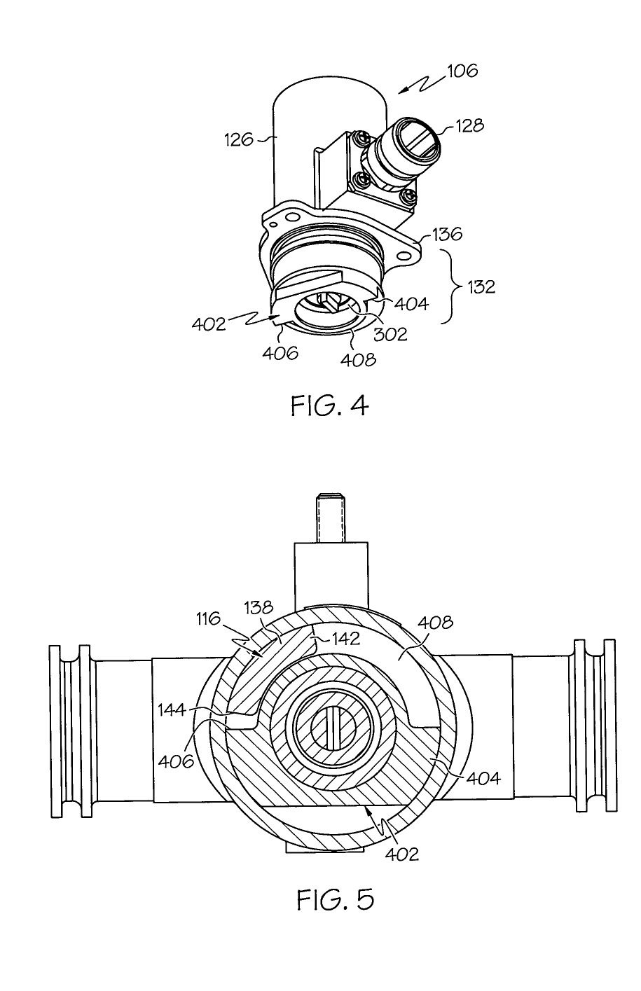

With reference now to FIG. 5, it is seen that, when the valve assembly 100 is assemble, the engagement structure 116 and the stop structure 402 are disposed adjacent one another. More particularly, the engagement structure main body 138 is disposed at least partially within the stop structure cavity 408. With this configuration, when the actuator assembly 106 moves the valve element 104 between the open and closed positions, the engagement structure first 142 and second 144 engagement surfaces engage the stop structure first 404 and second 406 stop surfaces, respectively. Thus, physical movement of the valve element 104 is limited at the open and closed positions of the valve element 104. It will be appreciated that, in the depicted embodiment, the stroke of the valve element 104 between the open and closed positions is about 110-degrees. Thus, since the arcuate cavity 408, in the depicted embodiment, spans approximately 180-degrees, the engagement structure main body 138 spans approximately 70-degrees, to thereby coincide with the open and closed positions of the valve element 104. It will be appreciated that the angular span of both the stop structure arcuate cavity 408 and the engagement structure main body 138 may be different than that shown in the depicted embodiment, and that the valve assembly 100 could additionally be configured to have an open-to-close valve stroke that differs from 110-degrees.

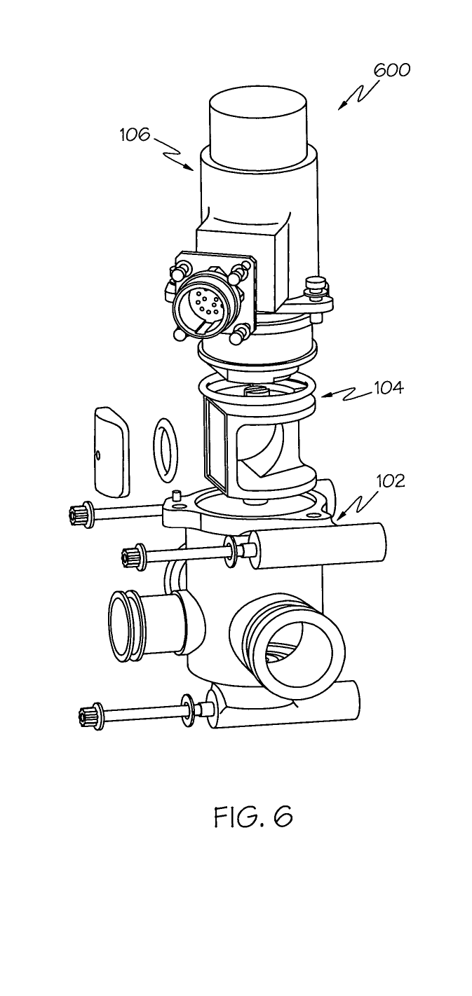

The valve assembly 100 depicted in FIGS. 1-6 and described above is implemented as a two port valve. However, it will be appreciated that the valve assembly 100 could be configured with more than this number of ports. For example, an exploded perspective view of a three port valve assembly 600 is illustrated in FIG. 6.

The valve assembly 100 configuration described above incorporates the mechanical hard stops in the actuator assembly 106. Thus, the valve assembly 100 includes fewer parts between the actuator assembly 106 and the hard stops, which provides increased torsional rigidity and less tolerance build up at the mechanical stop locations. Including the mechanical hard stops in the actuator assembly 106 also eliminates the difficult machining process used in certain valves.

While the invention has been described with reference to a preferred embodiment, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A valve assembly, comprising:
a valve body having at least a fluid inlet, and a fluid outlet;
a valve element disposed at least partially within the valve body and moveable between (i) an open position, in which the valve body fluid inlet is in fluid communication with the valve body fluid outlet, and (ii) a closed position, in which the valve body fluid inlet is not in fluid communication with the valve body fluid outlet;
an actuator assembly coupled to the valve element, the actuator assembly adapted to receive one or more position control signals and operable, in response thereto, to selectively move the valve element between the open and closed positions;
an engagement structure coupled to the valve element and moveable therewith; and
a stop structure fixedly coupled to the actuator assembly and configured to engage the engagement structure when the valve is at least in one of the open and closed positions.

2. The valve assembly of claim 1, wherein:
the engagement structure includes a first engagement surface and a second engagement surface;
the stop structure includes a first engagement surface and a second engagement surface;
the stop structure first surface engages the engagement structure first surface when the valve element is in the open position; and
the stop structure second surface engages the engagement structure second surface when the valve element is in the closed position.

3. The valve of claim 1, wherein:
the actuator assembly comprises a housing; and
the stop structure is machined into the actuator assembly housing.

4. The valve assembly of claim 1, wherein the engagement structure is machined into the valve element.

5. The valve assembly of claim 1, wherein the valve body includes an opening substantially transverse to the flow passage, the opening adapted to receive at least a portion of the actuator assembly therein, and wherein the actuator assembly comprises:
a housing having a valve interface section, the valve interface section extending into the valve via the valve body opening; and
an actuator element disposed within the housing and adapted to respond to the position control signals,
wherein the stop structure is coupled to the actuator assembly housing valve interface section.

6. The valve assembly of claim 5, wherein the stop structure is machined into the actuator assembly housing valve interface section.

7. The valve assembly of claim 1, wherein:
the valve element includes a shaft;
the actuator assembly is coupled to the valve element via the shaft; and
the engagement structure is coupled to the valve element proximate the shaft.

8. The valve assembly of claim 2, wherein the valve element includes at least a top surface, a bottom surface, and an outer surface, and wherein the engagement structure comprises:
a main body coupled to the valve element top surface and including (i) a first engagement surface configured to engage the stop structure when the valve is in the open position and (ii) a second engagement surface configured to engage the stop structure when the valve is in the closed position.

9. The valve assembly of claim 8, wherein the engagement structure first and second engagement surfaces are disposed substantially perpendicular to the valve element top surface.

10. The valve assembly of claim 8, wherein the stop structure comprises:
a main body including (i) a first stop surface configured to engage the first engagement surface when the valve is in the open position and (ii) a second stop surface configured to engage the second engagement surface when the valve is in the closed position.

11. A valve assembly, comprising:
a valve body having at least a fluid inlet, and a fluid outlet;
a valve element disposed at least partially within the valve body and moveable between (i) an open position, in which the valve body fluid inlet is in fluid communication with the valve body fluid outlet, and (ii) a closed position, in which the valve body fluid inlet is not in fluid communication with the valve body fluid outlet;
an actuator assembly coupled to the valve element, the actuator assembly adapted to receive one or more position control signals and operable, in response thereto, to selectively move the valve element between the open and closed positions;
an engagement structure coupled to the valve element and moveable therewith, the engagement structure including at least a first engagement surface and a second engagement surface; and
a stop structure fixedly coupled to the actuator assembly, the stop structure including (i) a first engagement surface configured to engage the engagement structure first surface when the valve is in the open position and (ii) a second engagement surface configured to engage the engagement structure second surface when the valve is in the closed position.

12. The valve of claim 11, wherein:
the actuator assembly comprises a housing; and
the stop structure is machined into the actuator assembly housing.

13. The valve assembly of claim 11, wherein the engagement structure is machined into the valve element.

14. The valve assembly of claim 11, wherein the valve body includes an opening substantially transverse to the flow passage, the opening adapted to receive at least a portion of the actuator assembly therein, and wherein the actuator assembly comprises:
a housing having a valve interface section, the valve interface section extending into the valve via the valve body opening; and
an actuator element disposed within the housing and adapted to respond to the position control signals,
wherein the stop structure is coupled to the actuator assembly housing valve interface section.

15. The valve assembly of claim 14, wherein the stop structure is machined into the actuator assembly housing valve interface section.

16. The valve assembly of claim 11, wherein:
the valve element includes a shaft;
the actuator assembly is coupled to the valve element via the shaft; and
the engagement structure is coupled to the valve element proximate the shaft.

17. The valve assembly of claim 11, wherein:
the valve element includes at least a top surface, a bottom surface, and an outer surface; and
the engagement structure is coupled to the valve element top surface.

18. The valve assembly of claim 17, wherein the first and second engagement surfaces are disposed substantially perpendicular to the valve element top surface.

19. The valve assembly of claim 18, wherein the first and second stop surfaces are disposed substantially parallel to the first and second engagement surfaces.

20. A valve assembly, comprising:
a valve body having at least a fluid inlet, and a fluid outlet;
a valve element disposed at least partially within the valve body and moveable between (i) an open position, in which the valve body fluid inlet is in fluid communication with the valve body fluid outlet, and (ii) a closed position, in which the valve body fluid inlet is not in fluid communication with the valve body fluid outlet;
an actuator assembly coupled to the valve element, the actuator assembly adapted to receive one or more position control signals and operable, in response thereto, to selectively move the valve element between the open and closed positions;
an engagement structure integrally formed as part of the valve element, the engagement structure including at least a first engagement surface and a second engagement surface; and
a stop structure integrally formed as part of the actuator assembly, the stop structure including (i) a first engagement surface configured to engage the engagement structure first surface when the valve is in the open position and (ii) a second engagement surface configured to engage the engagement structure second surface when the valve is in the closed position.
